(19) United States
(12) Patent Application Publication
(10) Pub. No.: US 2017/0019921 A1
(43) Pub. Date: Jan. 19, 2017

(54) UE RECOVERY MECHANISM DURING HS-SCCH DECODE FAILURE

(71) Applicant: QUALCOMM Incorporated, San Diego, CA (US)

(72) Inventors: Liangchi HSU, San Diego, CA (US); Sitaramanjaneyulu KANAMARLAPUDI, San Diego, CA (US); Penchal Prasad GODDETI, Sulzbach am Taunus (DE); Marian MADAN, Bad Soden am Taunus (DE); Dominique Francois BRESSANELLI, Eschborn (DE)

(21) Appl. No.: 15/003,333

(22) Filed: Jan. 21, 2016

Related U.S. Application Data
(60) Provisional application No. 62/193,488, filed on Jul. 16, 2015.

(51) Int. Cl. H04W 74/06; H04L 1/16; H04L 1/18; H04W 24/08; H04W 74/00

(52) U.S. Cl. CPC H04W 74/06; H04W 24/08; H04W 74/006; H04L 1/1812; H04L 1/1678

(57) ABSTRACT

Aspects of present methods and apparatus relating to recovering from a HS-SCCH decode failure during wireless communication are disclosed. The described aspects include detecting that one or more packet data units (PDUs) are being transmitted on an uplink channel, wherein at least one of the one or more PDUs includes a POLL BIT set to TRUE. The described aspects further include determining that a time period for unsuccessful downlink scheduling satisfies a threshold; and. The described aspects further include triggering a cell update procedure with a cell update cause set to Radio Link Control (RLC) unrecoverable error (UNREC ERROR) based on the determination that the one or more PDUs are being transmitted on the uplink channel and that the time period for unsuccessful downlink scheduling satisfies the threshold.

### CLAIM OF PRIORITY UNDER 35 U.S.C. §119

The present Application for Patent claims priority to U.S. Provisional Application No. 62/193,488 entitled “UE RECOVERY MECHANISM DURING HS-SCCH DECODE FAILURE” filed Jul. 16, 2015, which is assigned to the assignee hereof and hereby expressly incorporated by reference herein.

### BACKGROUND

Aspects of the present disclosure relate generally to wireless communication systems, and more particularly, to recovery from a High-Speed Shared Control Channel (HS-SCCH) decode failure during wireless communication.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

In some wireless communication networks, HS-SCCH decode failures may result in a disconnect between the network and a user equipment (UE) with regard to the downlink channel configuration. In these instances, the network may not be able to decode a High Speed-Dedicated Physical Control Channel (HS-DPCCH) properly and thus fails to acquire channel information from the UE. As a result, the UE may be transmitting data during a network disconnect, resulting in unnecessary use of transmission power and degraded user performance. Thus, improvements in recovering from a HS-SCCH decode failure during wireless communication are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a present method relates to recovering from a HS-SCCH decode failure during wireless communication. The described aspects include detecting that one or more packet data units (PDUs) are being transmitted on an uplink channel, wherein at least one of the one or more PDUs includes a POLL BIT set to TRUE. The described aspects further include determining that a time period for unsuccessful downlink scheduling satisfies a threshold. The described aspects further include triggering a cell update procedure with a cell update cause set to Radio Link Control (RLC) unrecoverable error (UNREC ERROR) based on the determination that the one or more PDUs are being transmitted on the uplink channel and that the time period for unsuccessful downlink scheduling satisfies the threshold.

In another aspect, a present computer-readable medium storing computer executable code relates to recovering from a HS-SCCH decode failure during wireless communication. The described aspects include code for detecting that one or more PDUs are being transmitted on an uplink channel, wherein at least one of the one or more PDUs includes a POLL BIT set to TRUE. The described aspects further include code for determining that a time period for unsuccessful downlink scheduling satisfies a threshold. The described aspects further include code for triggering a cell update procedure with a cell update cause set to RLC UNREC ERROR based on the determination that the one or more PDUs are being transmitted on the uplink channel and that the time period for unsuccessful downlink scheduling satisfies the threshold.

In a further aspect, a present apparatus relates to recovering from a HS-SCCH decode failure during wireless communication. The described aspects include means for detecting that one or more PDUs are being transmitted on an uplink channel, wherein at least one of the one or more PDUs includes a POLL BIT set to TRUE. The described aspects further include means for determining that a time period for unsuccessful downlink scheduling satisfies a threshold. The described aspects further include means for triggering a cell update procedure with a cell update cause set to RLC UNREC ERROR based on the determination that the one or more PDUs are being transmitted on the uplink channel and that the time period for unsuccessful downlink scheduling satisfies the threshold.

In another aspect, a present apparatus relates to recovering from a HS-SCCH decode failure during wireless communication. The described aspects include a memory configured to store data, and one or more processors communicatively coupled with the memory, wherein the one or more processors and the memory are configured to detect that one or more PDUs are being transmitted on an uplink channel, wherein at least one of the one or more PDUs includes a POLL BIT set to TRUE. The described aspects further determine that a time period for unsuccessful downlink scheduling satisfies a threshold. The described aspects further trigger a cell update procedure with a cell update cause set to RLC UNREC ERROR based on the determination that the one or more PDUs are being transmitted on the uplink channel and that the time period for unsuccessful downlink scheduling satisfies the threshold.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

The accompanying drawings are presented to aid in the description of various aspects of the disclosure and are provided solely for illustration of the aspects and not limitation thereof. The drawings include like reference numbers for like elements, and may represent optional components or actions using dashed lines.

FIG. 1 is a schematic diagram illustrating a detailed example architecture of aspects of the UE recover from a HS-SCCH decode failure as described throughout the present disclosure.

FIG. 2 is a flow diagram illustrating an exemplary method in a wireless communication system relating to the UE recovering from a decode failure.

FIG. 3 is a flow diagram illustrating an exemplary method in a wireless communication system relating to the UE recovering from a decode failure.

FIG. 4 is a diagram illustrating an aspect for recovering from a decode failure in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

The present aspects generally relate to recovering from a HS-SCCH decode failure in response to detecting internal device issues. For example, the network may transmit an HS-SCCH Order to a UE to configure carrier information. Once the HS-SCCH Order is transmitted, the network (e.g., a network entity such as a NodeB) may wait for an Acknowledgement (ACK) or Negative-Acknowledgement (NACK) signal on the uplink channel in response to the HS-SCCH Order. In instances where there is no response on the uplink channel, the network may re-transmit one or more HS-SCCH Orders. If the network has still yet to receive a response on the uplink channel, then the network may trigger Radio Resource Control (RRC) signalling to activate/deactivate the configuration. In certain instances, a UE may be operating in Multi-Subscriber Identity Module (SIM) mode, with tune-away configured, and so, there is a greater likelihood that the original HS-SCCH Order and the subsequent re-transmission will result in failures (e.g., as they may be transmitted during the tune away gap, and hence not be received at the UE operating in the Multi-SIM mode). As a result, the UE may not properly receive and/or may not be able to properly decode the HS-SCCH Order, and a disconnect between the network and the UE may occur in terms of the downlink channel configuration due to the network triggering the RRC signalling. For instance, the network may assume successful receipt and completion of the HS-SCCH Order, and may proceed with implementing a target configuration associated with the HS-SCCH Order. This results in the disconnect between the network and UE in terms of the downlink (DL) channel configuration, which impacts the HS-DPCCH encoding in the uplink (UL) channel, thereby causing the disconnect. Thus, the disconnect may impact the HS-DPCCH encoding in the uplink channel since the network will not be able to decode HS-DPCCH properly.

Additionally, because the network may not be able to decode the uplink, the network may fail to acquire a Channel Quality Indication (CQI) for HS-DPCCH from the UE. For example, this may be because the encoding for a single CQI and the encoding for dual CQI use different Reed-Muller tables, which give incompatible codewords. Also, for example, the network is not known to confirm HS-SCCH order reception by comparing the respective energies of single CQI codeword hypothesis and double CQI codeword hypothesis.

As a result, the UE may be transmitting data during a network disconnect, resulting in unnecessary use of transmission power and degraded user performance. For example, the UE may be transmitting PDUs on the uplink channel and receiving acknowledgement signals on the downlink channel even though there is no scheduling in the downlink channel due to HS-DPCCH decode failure at the network side. This may occur because even during this disconnect between the network and UE, as enhanced uplink channel encoding and associated Hybrid Automatic Repeat Request (ARQ) Indicator Channel (HICH) decoding are not changed, all the uplink data transmissions are getting properly acknowledged. As a result, even though all of the data packets in the uplink channel are being HICH ACK in the downlink channel there is no scheduling in the downlink channel due to the HS-DPCCH decode failure at the network. As such, the network is not sending new data on the downlink channel as well as not acknowledging any data packets which are received on the uplink channel.

The UE would be continuously sending data packets until the RLC window is full and/or if one of the one or more PDUs reaches a maxDAT retransmissions which would then trigger an RLC RESET. As such, the UE would essentially be discarding a window full of data packets on the uplink channel due to the unsuccessful downlink scheduling. Moreover, without directly triggering the cell update procedure with a cell update cause set to RLC UNREC ERROR, the UE would be continuously retransmitting data packets on the uplink until the cell update procedure is eventually triggered which wastes power without any successful transmission of data packets. These delays cause the UE to recover too slowly, for example, a full window may comprise 2048 PDUs. Moreover, the POLL timer expiration may correspond to 200 ms. Additionally, a maxDAT value may correspond to 16 until a RLC RESET is triggered while a maxRST value may correspond to 16 until the RLC UNREC ERROR is set for the cell update procedure.

Accordingly, in some aspects, the present methods and apparatuses may provide an efficient solution, as compared to current solutions, by adapting recovery to be initiated more quickly in a downlink disconnect condition between the UE and a network entity. For example, the UE is prevented from erroneously transmitting data packets on the uplink channel when there is no scheduling on the downlink channel. As such, in the present aspects, a UE may recover from a HS-SCCH decode failure in order to save transmission power and improve user performance by avoiding unnecessary transmissions of data during a network disconnect. In particular, the present aspects provide one or more mechanisms for quick recovery by utilizing physical (PHY) layer information, including detecting that one or more PDUs are being transmitted on an uplink channel, wherein at least one of the one or more PDUs includes a POLL BIT set to TRUE, determining that a time period for unsuccessful downlink scheduling satisfies a threshold, and triggering a cell update procedure with a cell update cause set to RLC UNREC ERROR based on the determination that the one or more PDUs are being transmitted on the uplink channel and that the time period for unsuccessful downlink scheduling satisfies the threshold.

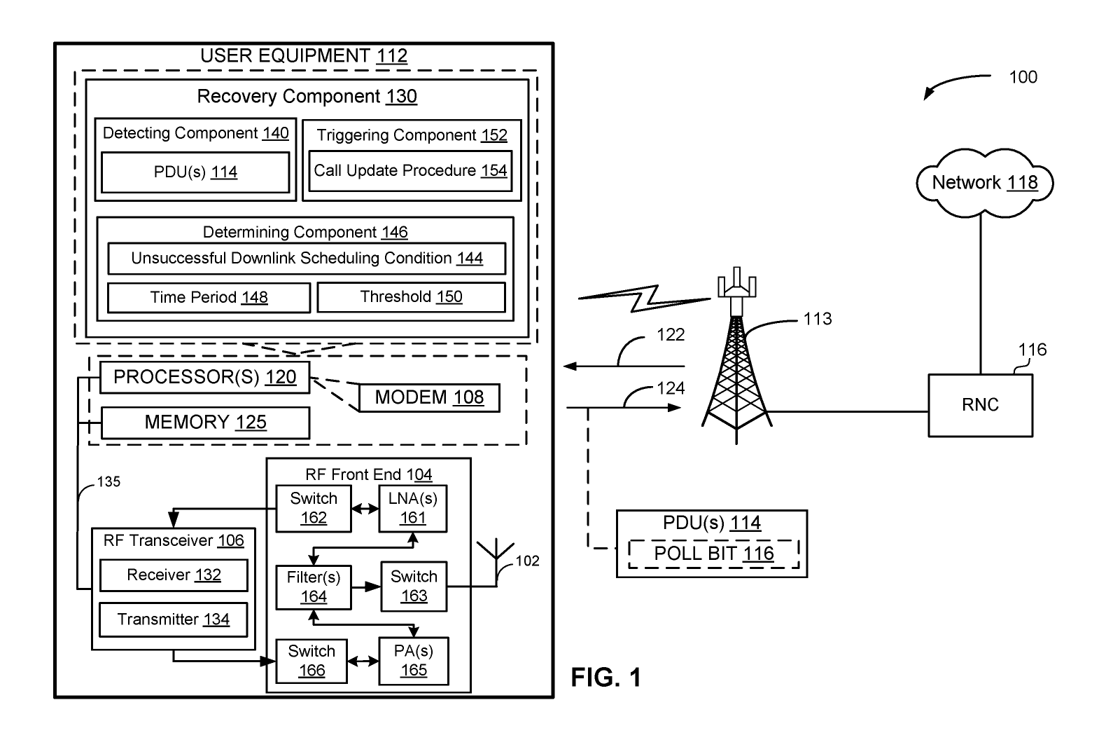

Referring to FIG. 1, in an aspect, a wireless communication system 100 includes at least one UE 112 in communication coverage of at least one network entity 113 (e.g., base station or node B). UE 112 can communicate with a network 118 via network entity 113 and a radio network control (RNC) 116. In an aspect, UE 112 may include one or more processors 120 and, optionally, memory 125, that may operate in combination with recovery component 130 to recover from a HS-SCCH decode failure in order to save transmission power and improve user performance by avoiding unnecessary transmissions of data during a network disconnect. In other words, recovery component 130 may operate to adapt a recovery of UE 112 by modifying a HARQ NACK scheme.

In an aspect, the network entity 113 may be a base station such a NodeB in an UMTS network. UE 112 may communicate with a network 118 via network entity 113 and a RNC 116. In some aspects, multiple UEs including UE 112 may be in communication coverage with one or more network entities, including network entity 113. In an example, UE 112 may transmit and/or receive wireless communications 20 to and/or from network entity 113.

In some aspects, UE 112 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. A UE 112 may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, a device for the Internet-of-Things, or any other similar functioning device. Additionally, network entity 113 may be a macrocell, picocell, femtocell, relay, Node B, mobile Node B, UE (e.g., communicating in peer-to-peer or ad-hoc mode with UE 112), or substantially any type of component that can communicate with UE 112 to provide wireless network access at the UE 112.

The wireless communications between the UE 112 and the network entity 113 may include signals transmitted by either the network entity 113 or the UE 112. The wireless communications may include downlink channels 122 transmitted by network entity 113 and uplink channels 124 transmitted by UE 112. For example, the network entity 113 may transmit one or more downlink channels 122 such as, but not limited to, a High-Speed Shared Control Channel (HS-SCCH), a high-speed downlink shared channel (HS-DSCH), high-speed physical downlink shared channel (HS-PDSCH), downlink dedicated physical control channel (DL-DPCCH), a fractional dedicated physical channel (F-DPCH), or Hybrid Automatic Repeat Request (ARQ) Indicator Channel (HICH). Further, for example, UE 112 may transmit uplink channel 124 such as, but not limited to, uplink High Speed-Dedicated Physical Control Channel (HS-DPCCH).

In an aspect, the one or more processors 120 may include a modem 108 that uses one or more modem processors. The various functions related to recovery component 130 may be included in modem 108 and/or processors 120 and, in an aspect, can be executed by a single processor, while in other aspects, different ones of the functions may be executed by a combination of two or more different processors. For example, in an aspect, the one or more processors 120 may include any one or any combination of a modem processor, or a baseband processor, or a digital signal processor, or a transmit processor, or a transceiver processor associated with transceiver 106. In particular, the one or more processors 120 may execute functions and components included in recovery component 130, including a detecting component 140, determining component 146, and a triggering component 152.

According to the present aspects, recovery component 130 may include hardware and/or software executable by processor 120 and, optionally, memory 125, for processing messages received through the wireless communications channel in order to recover from a HS-SCCH decode failure in order to save transmission power and improve user performance by avoiding unnecessary transmissions of data during a network disconnect. For example, recovery component 130 may include detecting component 140, which may be configured to detect that one or more PDUs are being transmitted on an uplink channel, wherein at least one of the one or more PDUs includes a POLL BIT set to TRUE. Detecting component 140 may be implemented on UE 112 in hardware, such as in one or more processor modules, or in software such as in computer-readable code or instructions stored on a computer readable medium and executed by one or more processors, or as some combination of both. Recovery component 130 may include determining component 146, which may be configured to determine or identify that downlink scheduling has not been received (e.g., an unsuccessful downlink scheduling condition 144) in a period of time in response to a HSDPCCH decode failure at the network entity 113. Determining component 146 may be implemented on UE 112 in hardware, such as in one or more processor modules, or in software such as in computer-readable code or instructions stored on a computer readable medium and executed by one or more processors, or as some combination of both. Further, determining component 146 may be configured to determine that a time period for unsuccessful downlink scheduling condition 144 satisfies a threshold 150. Determining component 146 may be implemented on UE 112 in hardware, such as in one or more processor modules, or in software such as in computer-readable code or instructions stored on a computer readable medium and executed by one or more processors, or as some combination of both. Moreover, recovery component 130 may include triggering component 152, which may be configured to trigger a cell update procedure with a cell update cause set to RLC UNREC ERROR based on the determination that the one or more PDUs are being transmitted on the uplink channel and that the time period for unsuccessful downlink scheduling condition 144 satisfies the threshold 150. Triggering component 152 may be implemented on UE 112 in hardware, such as in one or more processor modules, or in software such as in computer-readable code or instructions stored on a computer readable medium and executed by one or more processors, or as some combination of both.

Moreover, in an aspect, UE 112 may include RF front end 104 and transceiver 106 for receiving and transmitting radio transmissions, for example, wireless communications transmitted by the network entity 113. In an aspect, transceiver 106 may include at least one transmitter 134 and at least one receiver 132. For example, transceiver 106 may include receiver 132 for receiving a packet on the HS-SCCH (e.g., downlink channel 122) transmitted by the network entity 113. For example, transceiver 106 may include transmitter 134 and communicate with modem 108 to transmit messages generated by recovery component 130 and to receive messages and forward them to recovery component 130.

RF front end 104 may be connected to one or more antennas 102 and can include one or more low-noise amplifiers (LNAs) 161, one or more switches 162, 163, 165, one or more power amplifiers (PAs) 165, and one or more filters 164 for transmitting and receiving RF signals on the uplink channels 124 and downlink channels 22. In an aspect, components of RF front end 104 can connect with transceiver 106. Transceiver 106 may connect to one or more modems 108 and processor 120.

In an aspect, LNA 161 can amplify a received signal at a desired output level. In an aspect, each LNA 161 may have a specified minimum and maximum gain values. In an aspect, RF front end 104 may use one or more switches 162, 163 to select a particular LNA 161 and its specified gain value based on a desired gain value for a particular application.

Further, for example, one or more PA(s) 165 may be used by RF front end 104 to amplify a signal for an RF output at a desired output power level. In an aspect, each PA 165 may have a specified minimum and maximum gain values. In an aspect, RF front end 104 may use one or more switches 163, 166 to select a particular PA 165 and its specified gain value based on a desired gain value for a particular application.

Also, for example, one or more filters 164 can be used by RF front end 104 to filter a received signal to obtain an input RF signal. Similarly, in an aspect, for example, a respective filter 164 can be used to filter an output from a respective PA 165 to produce an output signal for transmission. In an aspect, each filter 164 can be connected to a specific LNA 161 and/or PA 165. In an aspect, RF front end 104 can use one or more switches 162, 163, 166 to select a transmit or receive path using a specified filter 164, LNA, 161, and/or PA 165, based on a configuration as specified by transceiver 106 and/or processor 120.

Transceiver 106 may be configured to transmit and receive wireless signals through antenna 102 via RF front end 104. In an aspect, transceiver may be tuned to operate at specified frequencies such that UE 112 can communicate with, for example, network entity 113. In an aspect, for example, modem 108 can configure transceiver 106 to operate at a specified frequency and power level based on the UE configuration of the UE 112 and communication protocol used by modem 108.

In an aspect, modem 108 can be a multiband-multimode modem, which can process digital data and communicate with transceiver 106 such that the digital data is sent and received using transceiver 106. In an aspect, modem 108 can be multiband and be configured to support multiple frequency bands for a specific communications protocol. In an aspect, modem 108 can be multimode and be configured to support multiple operating networks and communications protocols. In an aspect, modem 108 can control one or more components of UE 112 (e.g., RF front end 104, transceiver 106) to enable transmission and/or reception of signals from the network based on a specified modem configuration. In an aspect, the modem configuration can be based on the mode of the modem and the frequency band in use. In another aspect, the modem configuration can be based on UE configuration information associated with UE 112 as provided by the network during cell selection and/or cell reselection.

UE 112 may further include a memory 125, such as for storing data used herein and/or local versions of applications or recovery component 130 and/or one or more of its subcomponents being executed by processor 120. Memory 125 can include any type of computer-readable medium usable by a computer or processor 120, such as random access memory (RAM), read only memory (ROM), tapes, magnetic discs, optical discs, volatile memory, non-volatile memory, and any combination thereof. In an aspect, for example, memory 125 may be a computer-readable storage medium that stores one or more computer-executable codes defining recovery component 130 and/or one or more of its subcomponents, and/or data associated therewith, when UE 112 is operating processor 120 to execute recovery component 130 and/or one or more of its subcomponents.

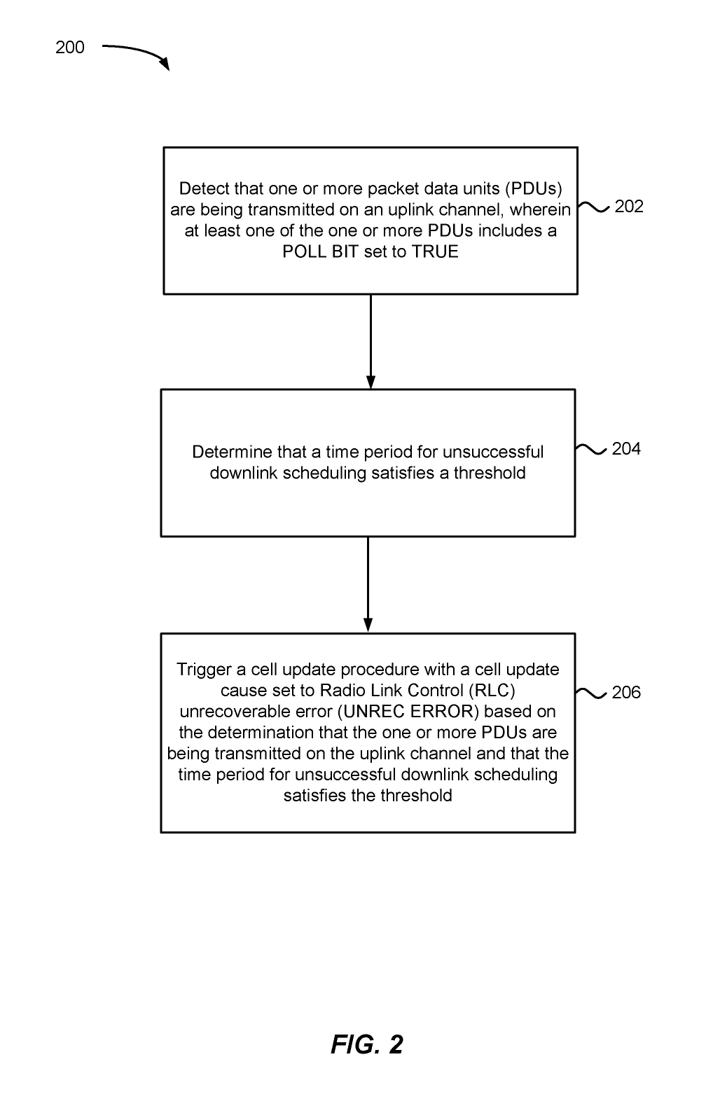

Referring to FIG. 2, an example of one or more operations and/or an example of architectural layout and components and subcomponents (FIG. 1) of an aspect of one or more processor(s) 120 (FIG. 1) according to the present apparatus and methods are described with reference to one or more methods and one or more components that may perform the actions of these methods. Although the operations described below are presented in a particular order and/or as being performed by an example component, it should be understood that the ordering of the actions and the components performing the actions may be varied, depending on the implementation. Also, although the one or more processor(s) 120 is illustrated as having a number of subcomponents, it should be understood that one or more of the illustrated subcomponent may be separate from, but in communication with, the one or more processor(s) 120 and/or each other. Moreover, it should be understood that the following actions or components described with respect to the one or more processor(s) 120 and/or its subcomponents may be performed by a specially-programmed processor, a processor executing specially-programmed software or computer-readable media, or by any other combination of a hardware component and/or a software component specially configured for performing the described actions or components.

In an aspect, at block 202, method 200 includes detecting that one or more PDUs are being transmitted on an uplink channel, wherein at least one of the one or more PDUs includes a POLL BIT set to TRUE. In an aspect, for example, one or more processor(s) 120, may execute recovery component 130 (FIG. 1) and/or detecting component 140 to detect that one or more PDUs are being transmitted on an uplink channel, wherein at least one of the one or more PDUs 114 includes a POLL BIT set to TRUE. For example, recovery component 130 may parse the one or more PDUs 114 to examine a known location of the POLL BIT to determine the value. Further, recovery component 130 (FIG. 1) and/or detecting component 140 may receive Hybrid Automatic Repeat Request (ARQ) Indicator Channel (HICH) Negative Acknowledgement (NACK) signals at a Physical (PHY) layer in response to transmitting the one or more PDUs to a network entity. In an aspect, the one or more PDUs 114 may be transmitted by RF transceiver 106 and/or transmitter 134.

In an aspect, at block 204, method 200 includes determining that a time period for unsuccessful downlink scheduling satisfies a threshold. In an aspect, for example, one or more processor(s) 120, may execute recovery component 130 (FIG. 1) and/or determining component 146 to determine that a time period for unsuccessful downlink scheduling condition 144 satisfies a threshold 150. In an aspect, determining component 146 may expect scheduling information from the network based on the POLL BIT being set to TRUE. As such, if the scheduling information is not received from within a specific period of time then, UE 112 and/or recovery component 130 establishes that a failure has occurred. For example, the threshold 150 is established based on a sum of a product of a maximum data (maxDAT) and a round trip time (RTT) and a product of a max reset (max RST) and the RTT. Moreover, recovery component 130 (FIG. 1) and/or establishing component 142 may identify the unsuccessful downlink scheduling condition 144 in response to a High Speed-Dedicated Physical Control Channel (HS-DPCCH) decode failure at a network entity, wherein the HS-DPCCH decode failure results in unacknowledged receipt by the network entity of transmissions by the UE to the network entity.

In an aspect, at block 206, method 200 includes triggering a cell update procedure with a cell update cause set to RLC UNREC ERROR based on the determination that the one or more PDUs are being transmitted on the uplink channel and that the time period for unsuccessful downlink scheduling satisfies the threshold 150. In an aspect, for example, one or more processor(s) 120, may execute recovery component 130 (FIG. 1) and/or triggering component 152 to trigger a cell update procedure with a cell update cause set to RLC UNREC ERROR based on the determination that the one or more PDUs are being transmitted on the uplink channel and that the time period for unsuccessful downlink scheduling condition 144 satisfies the threshold 150. In some aspects, UE 112 and/or transmitter 134 may send a CELL UPDATE message with an IE “AM_RLC error indication (RB2, RB3 or RB4)” or “AM_RLC error indication (RB>4)” set to “TRUE” to indicate the RLC unrecoverable errorhasoccurred in control plane or in the user plane. For example, triggering the cell update procedure with the cell update cause set to RLC UNREC ERROR releases an ongoing voice call and transitions the UE to an IDLE mode. In contrast to triggering the cell update procedure, UE 112 would be continuously sending data packets until the RLC window is full and/or if one of the one or more PDUs 114 reaches a maxDAT retransmissions which would then trigger an RLC RESET. As such, UE 112 would essentially be discarding a window full of data packets on the uplink channel due to the unsuccessful downlink scheduling. Moreover, without directly triggering the cell update procedure with a cell update cause set to RLC UNREC ERROR, UE 112 would be continuously retransmitting data packets on the uplink until the cell update procedure is eventually triggered which wastes power without any successful transmission of data packets.

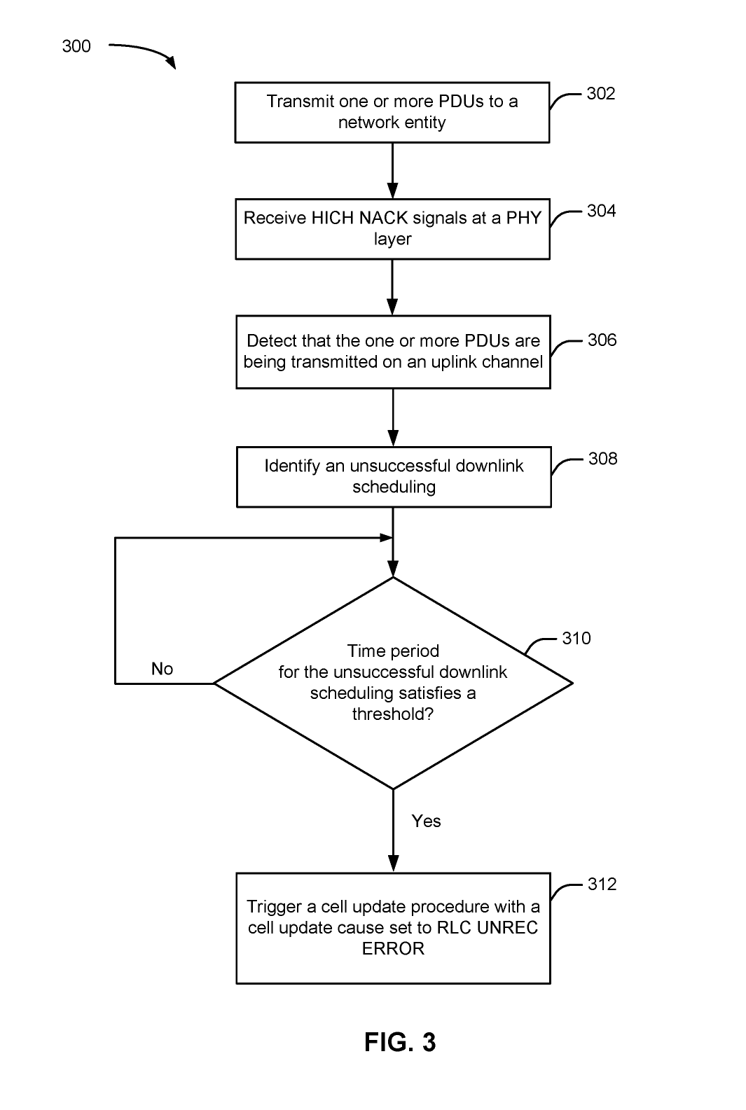

Referring to FIG. 3, an example of one or more operations and/or an example of architectural layout and components and subcomponents (FIG. 1) of an aspect of one or more processor(s) 120 and, optionally, memory 125 (FIG. 1) according to the present apparatus and methods are described with reference to one or more methods and one or more components that may perform the actions of these methods. Although the operations described below are presented in a particular order and/or as being performed by an example component, it should be understood that the ordering of the actions and the components performing the actions may be varied, depending on the implementation. Also, although the one or more processor(s) 120 is illustrated as having a number of subcomponents, it should be understood that one or more of the illustrated subcomponent may be separate from, but in communication with, the one or more processor(s) 120 and/or each other. Moreover, it should be understood that the following actions or components described with respect to the one or more processor(s) 120 and/or its subcomponents may be performed by a specially-programmed processor, a processor executing specially-programmed software or computer-readable media, or by any other combination of a hardware component and/or a software component specially configured for performing the described actions or components.

In an aspect, at block 302, method 300 includes transmitting one or more PDUs to a network entity. In an aspect, for example, one or more processor(s) 120, may execute RF transceiver 106 (FIG. 1) and/or transmitter 134 to transmit one or more PDUs to a network entity. For example, the one or more PDUs may be transmitted with a POLL BIT set to TRUE.

In an aspect, at block 304, method 300 includes receiving HICH NACK signals at a PHY layer. In an aspect, for example, one or more processor(s) 120, may execute RF transceiver 106 (FIG. 1) and/or receiver 132 to receive HICH NACK signals at a PHY layer. For example, the network 113 may transmit the HICH NACK signals at the PHY layer in response to receiving the one or more PDUs from UE 112.

In an aspect, at block 306, method 300 includes detecting that one or more PDUs are being transmitted on an uplink channel. In an aspect, for example, one or more processor(s) 120, may execute recovery component 130 (FIG. 1) and/or detecting component 140 to detect that one or more PDUs are being transmitted on an uplink channel, wherein at least one of the one or more PDUs includes a POLL BIT set to TRUE.

In an aspect, at block 308, method 300 includes identifying an unsuccessful downlink scheduling. In an aspect, for example, one or more processor(s) 120, may execute recovery component 130 (FIG. 1) and/or determining component 146 to establish an unsuccessful downlink scheduling condition 144. For example, establishing component 142 may identify the unsuccessful downlink scheduling condition 144 in response to a HS-DPCCH decode failure at a network entity, wherein the HS-DPCCH decode failure results in unacknowledged receipt of transmissions to the network entity.

In an aspect, at block 310, method 300 includes determining whether a time period for the unsuccessful downlink scheduling condition satisfies a threshold. In an aspect, for example, one or more processor(s) 120, may execute recovery component 130 (FIG. 1) and/or determining component 146 to determine whether a time period for unsuccessful downlink scheduling condition 144 satisfies a threshold 150. For example, the threshold 150 is established based on a sum of a product of a maxDAT and a RTT and a product of a max RST and the RTT. If determining component 146 determines that a time period for unsuccessful downlink scheduling condition 144 fails to satisfiy a threshold 150, then method 300 repeat block 310. However, if determining component 146 determines that a time period for unsuccessful downlink scheduling condition 144 satisfies a threshold 150, then method 300 proceed to block 312.

In an aspect, at block 312, method 300 includes trigger a cell update procedure with a cell update cause set to RLC UNREC ERROR. In an aspect, for example, one or more processor(s) 120, may execute recovery component 130 (FIG. 1) and/or triggering component 152 to trigger a cell update procedure with a cell update cause set to RLC UNREC ERROR. For example, triggering a cell update procedure may re-establish downlink scheduling based on successful completion of the cell update procedure.

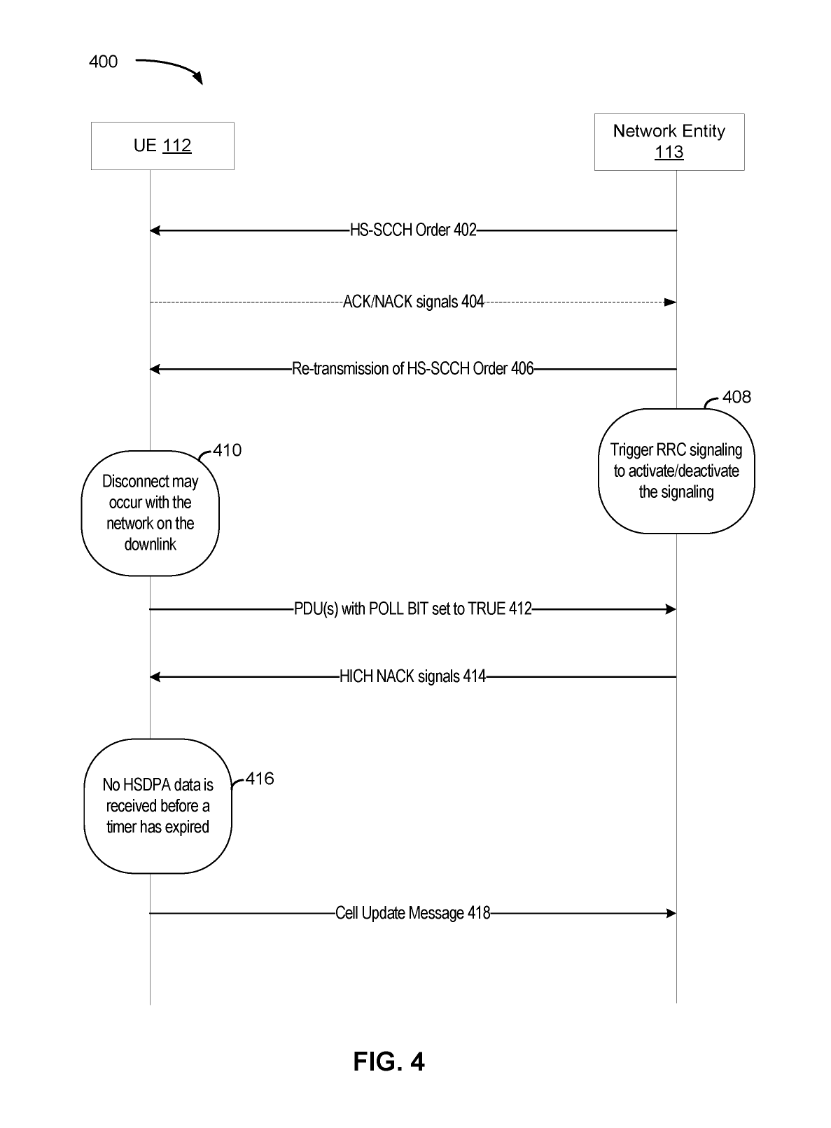

Referring to FIG. 4, in operation, signaling chart 400 illustrates signaling for recovering from decode failures during wireless communication between a UE and a network entity. In an aspect, signaling chart 400 illustrates an example implementation of method 200 of FIG. 2. In some aspects, the signaling chart illustrates the signaling between UE 112 and network entity 113. The UE may be located within a wireless communication system, such as wireless communication system 100 (FIG. 1). The UE may correspond to a UE, such as UE 112 (FIG. 1), and may include one or more processor(s), such as processor(s) 120, and/or memory 125 (FIG. 1) configured to execute a recovery component 130.

While, for purposes of simplicity of explanation, the steps herein are shown and described as a series of acts, it is to be understood and appreciated that the steps are not limited by the order of acts, as some acts may, in accordance with one or more aspects, occur in different orders and/or concurrently with other acts from that shown and described herein. For example, it is to be appreciated that the steps could alternatively be represented as a series of interrelated states or events, such as in a state diagram. Moreover, not all illustrated acts may be required to implement a step in accordance with one or more features described herein.

Referring to FIG. 4, signaling chart 400, in an aspect, at 402, network entity 113 may transmit an HS-SCCH Order to UE 112. For example, network entity 113 may transmit the HS-SCCH Order to UE 112 to configure carrier information. Once the HS-SCCH Order is transmitted, the network entity 113 may wait for an ACK or NACK signal on the uplink channel (e.g., uplink channel 124 of FIG. 1) in response to the HS-SCCH Order. At 404, UE 112 may potentially transmit the ACK or NACK signals on the uplink channel to network entity 113. At 406, if network entity 113 does not receive any ACK or NACK signals, then network entity 113 may re-transmit one or more HS-SCCH Orders. At 408, even if network entity 113 has still yet to receive a response on the uplink channel, then network entity 113 may trigger RRC signalling to activate/deactivate the network configuration with UE 112 based on an assumption as to the successful receipt of the HS-SCCH Order by UE 112. As a result, at 410, UE 112 may not have received, and/or may not be able to properly decode, the HS-SCCH Order and a disconnect between the network entity 113 and UE 112 may occur in terms of the downlink channel configuration (e.g., downlink channel 122 of FIG. 1).

At 412, even though there is a disconnect between network entity 113 and UE 112, UE 112 may still transmit one or more PDUs to network entity 113, including at least one PDU having a Poll Bit set to True. At 414, network entity 414 may transmit one or more HICH NACK signals to UE 112 in response to receiving the one or more PDUs. At 416, UE 112 may detect that the one or more PDUs are being transmitted on an uplink channel and that there is no HSDPA data received before a timer is expired (i.e., determine that a time period for receiving scheduling information on the downlink, e.g., an unsuccessful downlink scheduling condition 144 condition, satisfies a threshold 150). As a result, UE 112 may trigger a cell update procedure with a cell update cause set to RLC unrecoverable error UNREC ERROR. As such, at 418, UE 112 may transmit a cell update message to network entity 113 in order to re-establish downlink scheduling.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of recovering from decode failures during wireless communication, comprising:
detecting, at a user equipment (UE), that one or more packet data units (PDUs) are being transmitted on an uplink channel, wherein at least one of the one or more PDUs includes a POLL BIT set to TRUE;
determining that a time period for unsuccessful downlink scheduling satisfies a threshold; and
triggering a cell update procedure with a cell update cause set to Radio Link Control (RLC) unrecoverable error (UNREC ERROR) based on the determination that the one or more PDUs are being transmitted on the uplink channel and that the time period for unsuccessful downlink scheduling satisfies the threshold.

2. The method of claim 1, wherein the threshold is established based on a sum of a product of a maximum data (maxDAT) and a round trip time (RTT) and a product of a max reset (max RST) and the RTT.

3. The method of claim 1, further comprising identifying the unsuccessful downlink scheduling in response to a High Speed-Dedicated Physical Control Channel (HS-DPCCH) decode failure at a network entity, wherein the HS-DPCCH decode failure results in unacknowledged receipt of transmissions to the network entity.

4. The method of claim 1, wherein triggering the cell update procedure with the cell update cause set to RLC UNREC ERROR releases an ongoing voice call and transitions the UE to an IDLE mode.

5. The method of claim 1, further comprising re-establishing downlink scheduling based on successful completion of the cell update procedure.

6. The method of claim 1, further comprising receiving Hybrid Automatic Repeat Request (ARQ) Indicator Channel (HICH) Negative Acknowledgement (NACK) signals at a Physical (PHY) layer in response to transmitting the one or more PDUs to a network entity in association with determining that the time period for unsuccessful downlink scheduling satisfies the threshold, wherein triggering the cell update procedure is in response to both the receiving of the HICH NACK signals and the determining.

7. The method of claim 6, wherein receiving the HICH NACK signals at the PHY layer further comprises receiving the HICH NACK signals at the PHY layer during the unsuccessful downlink scheduling.

8. The method of claim 1, wherein the UE corresponds to either a single Subscriber Identity Module (SIM) UE or a multi-SIM UE.

9. An apparatus for recovering from decode failures during wireless communication, comprising:
a memory configured to store data, and
one or more processors communicatively coupled with the memory, wherein the one or more processors and the memory are configured to:
detect, at a user equipment (UE), that one or more packet data units (PDUs) are being transmitted on an uplink channel, wherein at least one of the one or more PDUs includes a POLL BIT set to TRUE;
determine that a time period for unsuccessful downlink scheduling satisfies a threshold; and
trigger a cell update procedure with a cell update cause set to Radio Link Control (RLC) unrecoverable error (UNREC ERROR) based on the determination that the one or more PDUs are being transmitted on the uplink channel and that the time period for unsuccessful downlink scheduling satisfies the threshold.

10. The apparatus of claim 9, wherein the threshold is established based on a sum of a product of a maximum data (maxDAT) and a round trip time (RTT) and a product of a max reset (max RST) and the RTT.

11. The apparatus of claim 9, wherein the one or more processor and the memory are configured to establish the unsuccessful downlink scheduling in response to a High Speed-Dedicated Physical Control Channel (HS-DPCCH) decode failure at a network entity, wherein the HS-DPCCH decode failure results in unacknowledged receipt of transmissions to the network entity.

12. The apparatus of claim 9, wherein the one or more processor and the memory are configured to trigger the cell update procedure with the cell update cause set to RLC UNREC ERROR releases an ongoing voice call and transitions the UE to an IDLE mode.

13. The apparatus of claim 9, wherein the one or more processor and the memory are configured to re-establish downlink scheduling based on successful completion of the cell update procedure.

14. The apparatus of claim 9, wherein the one or more processor and the memory are configured to receive Hybrid Automatic Repeat Request (ARQ) Indicator Channel (HICH) Negative Acknowledgement (NACK) signals at a Physical (PHY) layer in response to transmitting the one or more PDUs to a network entity in association with determining that the time period for unsuccessful downlink scheduling satisfies the threshold, wherein triggering the cell update procedure is in response to both the receiving of the HICH ACK signals and the determining.

15. The apparatus of claim 14, wherein the one or more processor and the memory configured to receive the HICH NACK signals at the PHY layer are further configured to receive the HICH NACK signals at the PHY layer during the unsuccessful downlink scheduling.

16. The apparatus of claim 9, wherein the UE corresponds to either a single Subscriber Identity Module (SIM) UE or a multi-SIM UE.

17. An apparatus for recovering from decode failures during wireless communication, comprising:
means for detecting, at a user equipment (UE), that one or more packet data units (PDUs) are being transmitted on an uplink channel, wherein at least one of the one or more PDUs includes a POLL BIT set to TRUE;
means for determining that a time period for unsuccessful downlink scheduling satisfies a threshold; and
means for triggering a cell update procedure with a cell update cause set to Radio Link Control (RLC) unrecoverable error (UNREC ERROR) based on the determination that the one or more PDUs are being transmitted on the uplink channel and that the time period for unsuccessful downlink scheduling satisfies the threshold.

18. The apparatus of claim 17, wherein the threshold is established based on a sum of a product of a maximum data (maxDAT) and a round trip time (RTT) and a product of a max reset (max RST) and the RTT.

19. The apparatus of claim 17, further comprising means for establishing the unsuccessful downlink scheduling in response to a High Speed-Dedicated Physical Control Channel (HS-DPCCH) decode failure at a network entity, wherein the HS-DPCCH decode failure results in unacknowledged receipt of transmissions to the network entity.

20. The apparatus of claim 17, wherein the means for triggering the cell update procedure with the cell update cause set to RLC UNREC ERROR releases an ongoing voice call and transitions the UE to an IDLE mode.

21. The apparatus of claim 17, further comprising means for re-establishing downlink scheduling based on successful completion of the cell update procedure.

22. The apparatus of claim 17, further comprising means for receiving Hybrid Automatic Repeat Request (ARQ) Indicator Channel (HICH) Negative Acknowledgement (NACK) signals at a Physical (PHY) layer in response to transmitting the one or more PDUs to a network entity in association with determining that the time period for unsuccessful downlink scheduling satisfies the threshold, wherein triggering the cell update procedure is in response to both the receiving of the HICH ACK signals and the determining.

23. The apparatus of claim 22, wherein the means for receiving the HICH NACK signals at the PHY layer further comprises means for receiving the HICH NACK signals at the PHY layer during the unsuccessful downlink scheduling.

24. The apparatus of claim 17, wherein the UE corresponds to either a single Subscriber Identity Module (SIM) UE or a multi-SIM UE.

25. A computer-readable medium storing computer executable code for recovering from decode failures during wireless communication, comprising:
code for detecting, at a user equipment (UE), that one or more packet data units (PDUs) are being transmitted on an uplink channel, wherein at least one of the one or more PDUs includes a POLL BIT set to TRUE;
code for determining that a time period for unsuccessful downlink scheduling satisfies a threshold; and
code for triggering a cell update procedure with a cell update cause set to Radio Link Control (RLC) unrecoverable error (UNREC ERROR) based on the determination that the one or more PDUs are being transmitted on the uplink channel and that the time period for unsuccessful downlink scheduling satisfies the threshold.

26. The computer-readable medium of claim 25, wherein the threshold is established based on a sum of a product of a maximum data (maxDAT) and a round trip time (RTT) and a product of a max reset (max RST) and the RTT.

27. The computer-readable medium of claim 25, further comprising code for establishing the unsuccessful downlink scheduling in response to a High Speed-Dedicated Physical Control Channel (HS-DPCCH) decode failure at a network entity, wherein the HS-DPCCH decode failure results in unacknowledged receipt of transmissions to the network entity.

28. The computer-readable medium of claim 25, wherein the code for triggering the cell update procedure with the cell update cause set to RLC UNREC ERROR releases an ongoing voice call and transitions the UE to an IDLE mode.

29. The computer-readable medium of claim 25, further comprising code for re-establishing downlink scheduling based on successful completion of the cell update procedure.

30. The computer-readable medium of claim 25, further comprising code for receiving Hybrid Automatic Repeat Request (ARQ) Indicator Channel (HICH) Negative Acknowledgement (NACK) signals at a Physical (PHY) layer in response to transmitting the one or more PDUs to a network entity in association with determining that the time period for unsuccessful downlink scheduling satisfies the threshold, wherein triggering the cell update procedure is in response to both the receiving of the HICH ACK signals and the determining.
